(19) United States
(12) Patent Application Publication
(10) Pub. No.: US 2026/0196646 A1
(43) Pub. Date: Jul. 9, 2026

(54) VENT MECHANISM FOR POUCH BATTERY CELLS

(71) Applicant: GM GLOBAL TECHNOLOGY OPERATIONS LLC, Detroit, MI (US)

(72) Inventors: William Reginald COLLIN, Dearborn, MI (US); James R. Salvador, East Lansing, MI (US); Jeremie Dernotte, Canon, MI (US); Jigang Zhou, Windsor (CA); Ratandeep Singh Kukreja, Auburn Hills, MI (US); Robert D, Schmidt, Bloomfield Hills, MI (US); Nicholas Paul William Pieczonka, Windsor (CA); zhongyi Liu, Troy, MI (US); Daad Bourhan Haddad, Warren, MI (US)

(21) Appl. No.: 19/012,416

(22) Filed: Jan. 7, 2025

(51) Int. Cl. H01M 50/342; B60L 50/64; H01M 10/42; H01M 50/105

(52) U.S. Cl. CPC H01M 50/3425; H01M 10/425; H01M 50/105; B60L 50/64; H01M 2010/4271; H01M 2220/20

(57) ABSTRACT

A pouch battery cell includes an anode including an anode terminal, a cathode including a cathode terminal, and an enclosure encapsulating the anode and the cathode. The enclosure is formed from a film having a surface. The anode terminal and the cathode terminal project outwardly from the enclosure. A vent mounted adjacent to the surface. The vent includes a housing including an opening, a biasing element having stored potential energy, and a selectively deployable spear operatively connected to the biasing element. The stored potential energy in the biasing element is selectively released to deploy the selectively deployable spear through the opening to penetrate the film and vent the enclosure.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to battery cells and, more particularly, to a vent mechanism for pouch battery cells.

Electric vehicles (EVs) such as battery electric vehicles (BEVs), hybrid vehicles, and/or fuel cell vehicles include one or more electric machines and a battery system including one or more battery cells, modules, and/or packs. A power control system is used to control charging and/or discharging of the battery system during charging and/or driving.

Battery cells include cathode electrodes, anode electrodes, and separators arranged in a battery cell stack located in a battery cell enclosure that may take the form of a pouch. The cathode electrodes include a cathode active material layer arranged on a cathode current collector. The anode electrodes include an anode active material layer arranged on an anode current collector. The cathode and anode electrodes are connected to cathode and anode terminals that pass out from the pouch. Battery modules or packs typically include a housing that supports and surrounds the battery cells. The terminals of the battery cells are interconnected to provide a desired output voltage.

### SUMMARY

A pouch battery cell, in accordance with the present disclosure, includes an anode including an anode terminal, a cathode including a cathode terminal, and an enclosure encapsulating the anode and the cathode. The enclosure is formed from a film having a surface. The anode terminal and the cathode terminal project outwardly from the enclosure. A vent mounted adjacent to the surface. The vent includes a housing including an opening, a biasing element having stored potential energy, and a selectively deployable spear operatively connected to the biasing element. The stored potential energy in the biasing element is selectively released to deploy the selectively deployable spear through the opening to penetrate the film and vent the enclosure.

In other features, the selectively deployable spear includes a shaft having a tip and an internal passage extending through the shaft, the internal passage having a first end including a first opening exposed along the shaft and a second end including a second opening exposed at the tip.

In other features, the internal passage includes a first passage section extending radially inwardly from the first opening and a second passage section extending axially along the shaft from the second opening, the first passage section being fluidically connected with the second passage section.

In other features, the vent includes a selectively activated trigger mechanism responsive to a stimulus generated in the enclosure.

In other features, the selectively activated trigger mechanism includes an electro-mechanical switch.

In other features, the selectively activated trigger mechanism includes an electro-magnetic switch.

In other features, the selectively activated trigger mechanism comprises a one of a phase changing material switch and a chemical reaction switch.

In other features, the stimulus includes one of a sensed gas, a sensed pressure, a sensed temperature in the enclosure, and a sensed phase change.

In other features, the selectively activated trigger mechanism includes a pneumatic switch.

In other features, the vent is mounted within the enclosure.

In other features, the selectively activated trigger mechanism is configured to be responsive to stimulus within the enclosure to release the selectively deployable spear.

In other features, the selectively activated trigger mechanism is mounted external to the enclosure.

In other features, the selectively activated trigger mechanism includes a conduit fluidically connected to a vent passage.

In other features, a battery monitoring system is configured to selectively disconnect the pouch battery cell upon detecting gases passing from the enclosure.

A method of venting gases from a battery pack including a pouch battery cell having an anode including an anode terminal, a cathode including a cathode terminal, and an enclosure encapsulating the anode and the cathode, the enclosure being formed from a film having a surface, the method includes detecting a stimulus in the enclosure, activating a trigger mechanism to release a spear after detecting the stimulus, and driving the spear though the surface of the film to vent the enclosure.

In other features, the method includes passing gases from the enclosure to a vent passage, exhausting the gases from the vent passage, and filtering the gases passing from the vent passage.

In other features, passing the gases from the enclosure included directing the gases through the spear.

In other features, passing the gases from the enclosure includes directing the gases from the triggering mechanism through a conduit selectively fluidically connecting the enclosure with the vent passage.

In other features, the method includes detecting gases in the vent passage with a battery monitoring system, and electrically isolating the pouch battery cell.

In other features, detecting the stimulus in the enclosure includes sensing one of a gas, a pressure, a temperature in the enclosure, and a sensed phase change.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a left side view of a vehicle including a pouch battery cell having a venting mechanism, in accordance with the present disclosure;

FIG. 2 is an elevational view of a pouch battery cell including an external venting mechanism, in accordance with an aspect of the present disclosure;

FIG. 3 is a plan view of a pouch battery cell of FIG. 2 depicting the external venting mechanism puncturing a pouch enclosing the battery cell, in accordance with the present disclosure;

FIG. 4 is a plan view of the external venting mechanism of FIG. 2 prior to venting, in accordance with an aspect of the present disclosure;

FIG. 5 is a plan view of the external venting mechanism of FIG. 4 after venting, in accordance with an aspect of the present disclosure;

FIG. 6 depicts a battery monitoring system (BMS) connected to the external venting mechanism, in accordance with the present disclosure;

FIG. 7 is a plan view of a venting mechanism prior to venting, in accordance with another aspect of the present disclosure;

FIG. 8 is a plan view of an external venting mechanism of FIG. 7 after venting, in accordance with another aspect of the present disclosure;

FIG. 9 is a flow chart depicting a method of venting pouch battery cells, in accordance with the present disclosure;

FIG. 10 is a plan view of a pouch battery cell including an internal venting mechanism, in accordance with another aspect of the present disclosure;

FIG. 11 is a plan view of the internal venting mechanism of FIG. 10 venting the pouch battery cell, in accordance with the present disclosure;

FIG. 12 is a plan view of the internal venting mechanism of FIG. 10, in accordance with an aspect of the present disclosure;

FIG. 13 is a plan view of the internal venting mechanism of FIG. 12, in accordance with an aspect of the present disclosure;

FIG. 14 is a plan view of the internal venting mechanism of FIG. 10, in accordance with another aspect of the present disclosure;

FIG. 15 is a plan view of the internal venting mechanism of FIG. 11, in accordance with another aspect of the present disclosure; and

FIG. 16 is a flow chart depicting a method of venting pouch battery cells, in accordance with the present disclosure.

In the drawings, reference numbers may be reused to identify similar and/or identical elements.

### DETAILED DESCRIPTION

While pouch battery cells according to the present disclosure are shown in the context of electric vehicles, the pouch battery cells can be used in stationary applications and/or other applications.

Prismatic can battery cells typically include a vent cap. During a thermal runaway event, the vent cap bursts to allow products of the thermal runaway event to exit the enclosure. The vent caps are typically arranged on an upper surface or on a bottom surface of a prismatic battery cell can. Arrangement on the upper or the bottom surface provides room for cooling systems that engage side surfaces of the prismatic can battery cell.

In contrast, pouch battery cells include an anode and a cathode encased in an aluminum-coated plastic film. Typically, two tabs or terminals extend out from the pouch. Pouch cells are lightweight, easy to construct, and may be mass produced at a price point that is significantly lower than prismatic can cells. While easier and less expensive to produce, current pouch battery cells lack structure that may be used to support a vent.

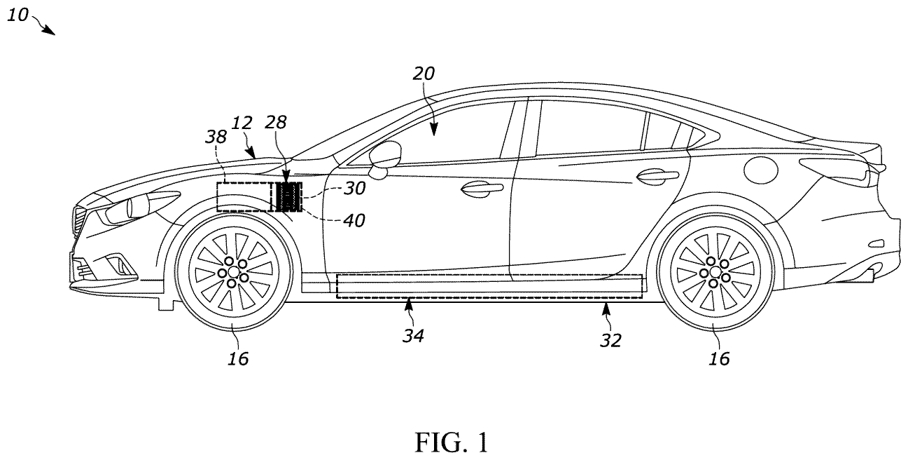

A vehicle, in accordance with a non-limiting example, is indicated generally at 10 in FIG. 1. Vehicle 10 includes a body 12 supported on a plurality of wheels, two of which are indicated at 16. Body 12 defines, in part, a passenger compartment 20. Body 12 includes a charge port cover 28 that houses a charge port 30. Vehicle 10 includes a chassis 32 that supports a battery assembly 34 electrically connected to charge port 30. Chassis 32 is further shown to support a motor 38 that is electrically connected to battery assembly 34 and a drive unit 40. Drive unit 40 transfers motive power from motor 38 to one or more of the plurality of wheels 16. While battery assembly 34 is shown and described in connection with a vehicle, the present disclosure is also applicable to battery assemblies in non-vehicle implementations.

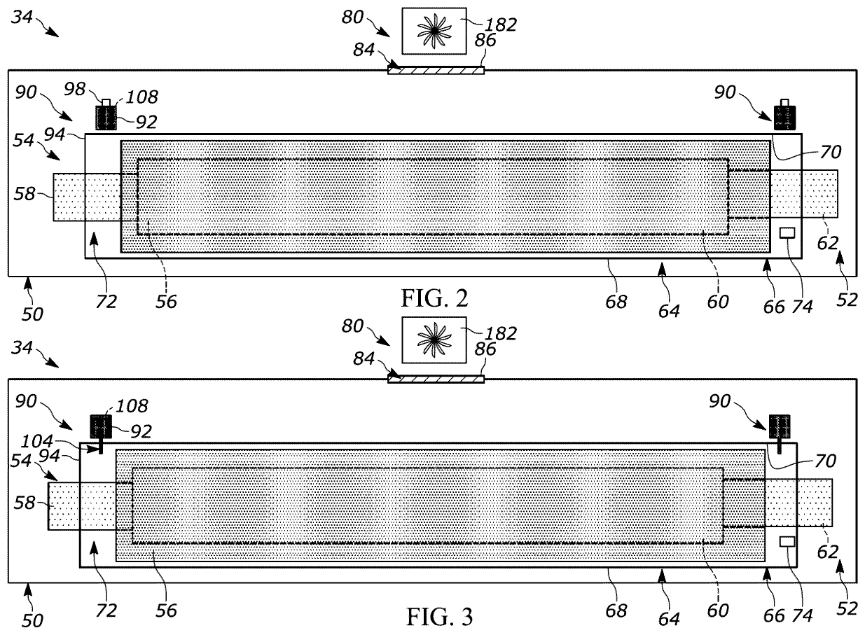

Referring to FIGS. 2 and 3, battery assembly 34 includes a battery cell housing 50 including an interior battery zone 52 within which are arranged a plurality of pouch battery cells, one of which is indicated at 54. Pouch battery cell 54 includes an anode 56 having an anode terminal 58 and a cathode 60 having a cathode terminal 62. Anode 56 and cathode 60 are encased in an enclosure 64 formed from a pliable film 66. Anode terminal 58 and cathode terminal 62 extend outward from enclosure 64 and serve as an interface with battery assembly 34 to provide power to motor 38. Film 66 includes an outer film surface 68 and an inner film surface 70. Enclosure 64 includes a cell interior 72 that, in addition to housing anode 56 and cathode 60, includes a gas sensor 74. Battery cell housing 50 is also shown to include a vent passage 80 having an outlet 84 provided with a filter 86.

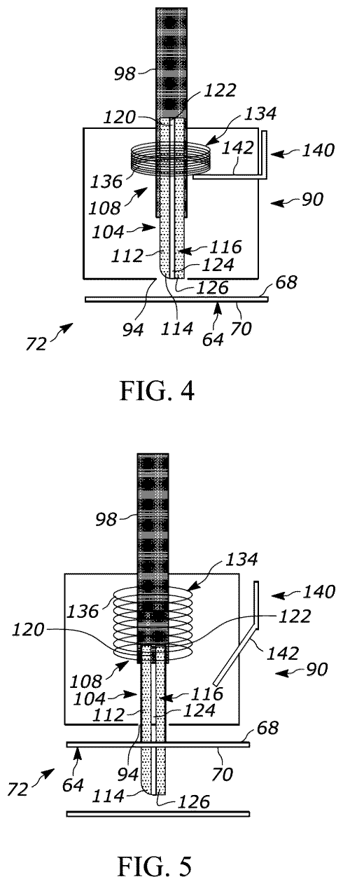

In accordance with the present disclosure, an external vent 90 selectively fluidically connects pouch battery cell 54 with vent passage 80. More specifically, external vent 90 may be connected to outer film surface 68 and acts to selectively fluidically connect cell interior 72 with vent passage 80. Referring to FIGS. 4 and 5, external vent 90 includes a vent housing 92 including an opening 94. Vent housing 92 includes a conduit 98 that extends into and fluidically connects with vent passage 80.

In accordance with the present disclosure, external vent 90 includes a spear 104 connected to triggering mechanism 108. Triggering mechanism 108 selectively releases spear 104 to extend from vent housing 92 and penetrate enclosure 64. As will be detailed more fully herein, spear 104 forms an opening in film 66 that allows gases to vent from cell interior 72 and pass into vent passage 80. Spear 104 includes a shaft 112 and a tip 114. An internal passage 116 extends from tip 114 through shaft 112. Internal passage 116 includes a first end 120 having a first opening 122 and a second end 124 having a second opening 126. When spear 104 is directed through film 66, internal passage 116 establishes a fluidic connection between cell interior 72 and interior battery zone 52.

In accordance with the present disclosure, triggering mechanism 108 includes a biasing element 134 that selectively urges spear 104 from vent housing 92 through film 66. Biasing element 134 shown in the form of a spring 136 that is restrained by a switch 140 which, in the non-limiting example shown in FIGS. 4 and 5, takes the form of an electro-mechanical device 142. Switch 140 is selectively released to release biasing element 134 and force spear 104 through film 66.

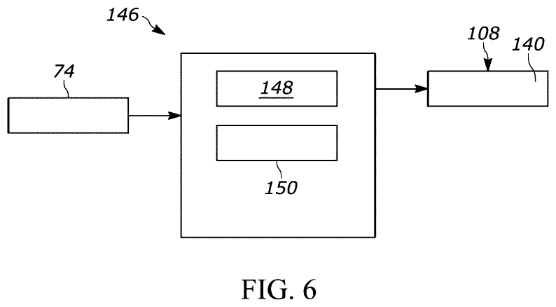

Referring to FIG. 6, a battery monitoring system (BMS) 146 is connected to gas sensor 74 and switch 140 of triggering mechanism 108. BMS 146 includes a central processing unit 148 and a battery monitoring module 150. Battery monitoring module 150 may take on various forms and could be a gas detection module, a pressure sensor module, a battery temperature module, and/or a phase change detection sensor. In the case of a sensed gas, battery monitoring module 150 determines if gas detected by gas sensor 74 in cell interior 72 exceeds a predetermined volume. If the predetermined volume is exceeded, BMS 146 activates switch 140 to release biasing element 134 causing spear 104 to penetrate film 66. Similarly, in the case of a pressure sensor module, battery monitoring module 150 determines whether pressure within cell interior 72 exceeds a selected pressure value. In the case of a temperature detection module, battery monitoring module 150 determines whether a temperature within cell interior 72 exceeds a selected temperature value. A phase change sensor will detect if a liquid converts to gas, a polymer reaches a softening or glass transition point, a degradation mode involving production of a new or additional phase material from the nominal cell composition, or similar physical state changes. If the predetermined volume, or a similar condition, or set of conditions from pressure temperature or phase change is exceeded, BMS 146 activates switch 140 to release biasing element 134 causing spear 104 to penetrate film 66.

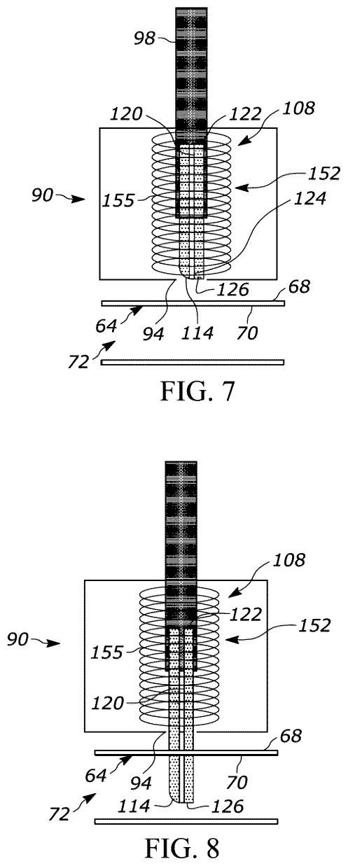

At this point, it should be understood that triggering mechanism 108 may take on various forms such as one including a biasing element 152 shown in the form of an electro-magnetic coil 155 as illustrated in FIGS. 7 and 8. Electro-magnetic coil 155 may be connected to BMS 146 and activated to drive spear 104 through film 66 (FIG. 8) when a predetermined amount of gas is detected within cell interior 72.

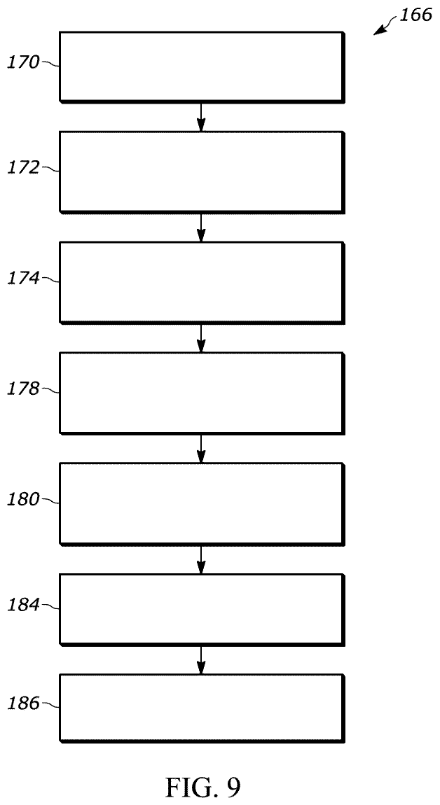

Reference will now follow to FIG. 9 in describing a method 166 for venting pouch battery cell 54 in accordance with the present disclosure. Gas generated by anode 56 and or cathode 60 in cell interior 72 is detected by gas sensor 74 in block 170. Gas sensor 74 may take on a variety of forms including a pressure sensor, a capacitance sensor, a temperature sensor, or the like. In block 172, BMS 146 signals triggering mechanism 108 to release switch 140 causing shaft 112 to penetrate film 66. In block 174, gas in cell interior 72 begins to vent through internal passage 116 in spear 104 into vent passage 80. In addition to activating switch 140, BMS 146, in block 178 triggers a protect mode. In block 180, BMS 146 activates a fan 182 drawing the gases from vent passage 80 through filter 86 to ambient. In block 184, BMS 146 electrically isolates pouch battery cell 54 from remaining battery cells in battery assembly 34 and in block 186, BMS 146 presents a notification to an operator of vehicle 10 indicating that battery assembly 34 may require service.

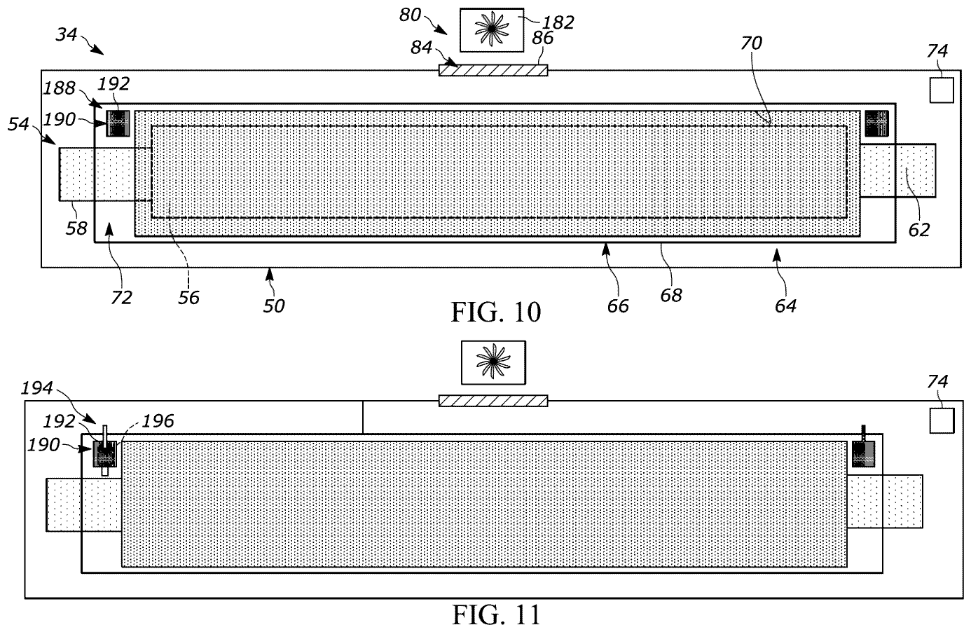

Reference will now follow to FIGS. 10 and 11, in describing an internal vent 188 in accordance with another aspect of the present disclosure. Internal vent 188 selectively fluidically connects cell interior 72 with vent passage 80. Internal vent 188 includes a vent housing 190 that may be mounted to inner film surface 70 and includes an opening 192. A spear 194 is arranged in vent housing 190. A triggering mechanism 196 is operatively connected to spear 194. Triggering mechanism 196 selectively extends spear 194 through opening 192 in order to puncture film 66.

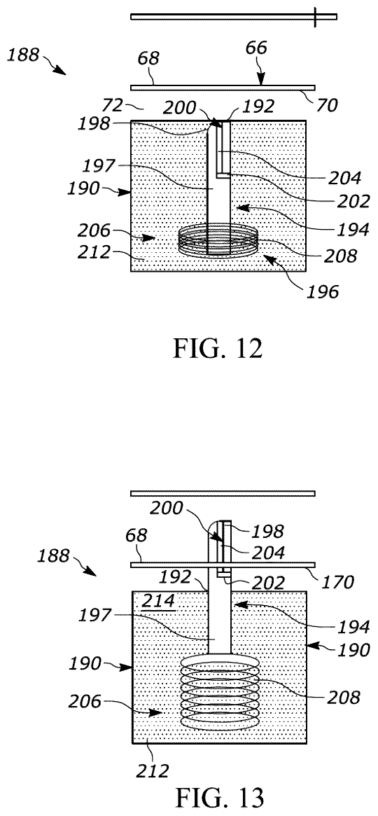

Referring to FIGS. 12 and 13, spear 194 includes a shaft 197 and a tip 198. An internal passage 200 extends through shaft 197. Internal passage 200 includes a first passage section 202 that passes radially through shaft 197 and a second passage section 204 that extends axially through shaft 197 and connects with first passage section 202. Internal vent 188 includes a biasing element 206, shown in the form of a spring 208, that selectively drives spear 194 through film 66. Triggering mechanism 196 includes a switch 210 that is responsive to stimulus produced in cell interior 76. The stimulus may be gases, pressure, temperature, or the like. Switch 210 may take the form of a phase change material 212 or a chemically reactive switch that produces a chemical reaction when exposed to a selected stimulus such as gas, pressure, temperature, or the like. Phase change material 212 changes from a solid, to a liquid when exposed to a selected temperature. In one aspect, phase change material 212 may take the form of wax 214. Hot gases that may be produces by pouch battery cells 54 may melt wax 214 thereby releasing spring 208 causing spear 194 to extend out from vent housing 190 and penetrate film 66.

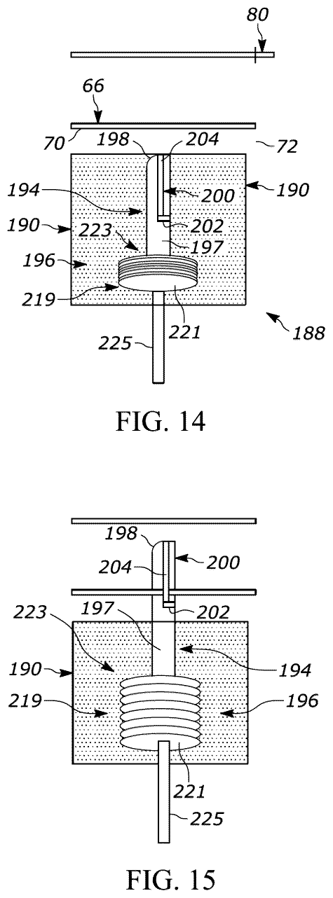

At this point, it should be understood that triggering mechanism 196 for internal vent 188 may take on various forms. For example, as shown in FIGS. 14 and 15, triggering mechanism 196 may include a biasing element 219 that takes the form of a bellows 221 which forms a pneumatic switch 223. Bellows 221 is connected to a conduit 225 that is exposed to cell interior 72. In the event gases build up in cell interior 72, the bellows 221 will expand (FIG. 15) driving spear 194 through film 66. The gases may then vent from cell interior 72 to vent passage 80 via internal passage 200 in spear 194.

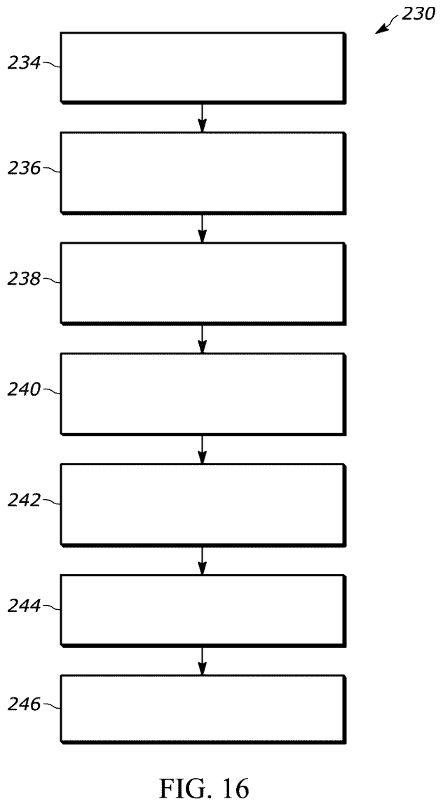

Reference will now follow to FIG. 16 in describing a method 230 of venting pouch battery cell 54 with internal vent 188, in accordance with the present disclosure. In the event a stimulus such as gas, pressure, and/or temperature is generated in cell interior 72, that stimulus interacts with trigger mechanism 196 in block 234. The stimulus activates trigger mechanism to deploy spear 194 in block 236. In block 238, gas begins to vent from cell interior 72 into vent passage 80. Gas is detected by gas sensor 74 in battery cell housing 50 in block 240. BMS 146, in block 242 activates fan 182 to removes gasses from interior battery zone 52. In block 244, BMS 146 activates a protect mode electrically isolating pouch battery cell 54 from remaining battery cells in battery assembly 34 and in block 246, BMS 146 presents a notification to operators indicating that battery assembly 34 may require service.

At this point, it should be understood that the present disclosure describes a system and method of venting pouch battery cells. The system includes a vent that puncture the pouch battery cell allowing gas to vent. The vent may be arranged outside of the pouch battery cell or within a cell interior of the pouch battery cell. Venting gas is detected by a battery monitoring system and prophylactic action is taken. Further, while described in the form of a pouch battery cell, the disclosed embodiments may be incorporated into other battery formats.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information, but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

What is claimed is

1. A pouch battery cell comprising:
an anode including an anode terminal;
a cathode including a cathode terminal;
an enclosure encapsulating the anode and the cathode, the enclosure being formed from a film having a surface, wherein the anode terminal and the cathode terminal project outwardly from the enclosure; and
a vent mounted adjacent to the surface, the vent including a housing including an opening, a biasing element having stored potential energy, and a selectively deployable spear operatively connected to the biasing element, the stored potential energy in the biasing element being selectively configured to deploy the selectively deployable spear through the opening to penetrate the film and vent the enclosure.

2. The pouch battery cell according to claim 1, wherein the selectively deployable spear includes a shaft having a tip and an internal passage extending through the shaft, the internal passage having a first end including a first opening exposed along the shaft and a second end including a second opening exposed at the tip.

3. The pouch battery cell according to claim 2, wherein the internal passage includes a first passage section extending radially inwardly from the first opening and a second passage section extending axially along the shaft from the second opening, the first passage section being fluidically connected with the second passage section.

4. The pouch battery cell according to claim 1, wherein the vent includes a selectively activated trigger mechanism responsive to a stimulus generated in the enclosure.

5. The pouch battery cell according to claim 4, wherein the selectively activated trigger mechanism includes an electro-mechanical switch.

6. The pouch battery cell according to claim 4, wherein the selectively activated trigger mechanism includes an electro-magnetic switch.

7. The pouch battery cell according to claim 4, wherein the selectively activated trigger mechanism comprises a one of a phase changing material switch and a chemical reaction switch.

8. The pouch battery cell according to claim 4, wherein the stimulus includes one of a sensed gas, a sensed pressure, a sensed temperature in the enclosure, and a sensed phase change.

9. The pouch battery cell according to claim 4, wherein the selectively activated trigger mechanism includes a pneumatic switch.

10. The pouch battery cell according to claim 4, wherein the vent is mounted within the enclosure.

11. The pouch battery cell according to claim 10, wherein the selectively activated trigger mechanism is configured to be responsive to stimulus within the enclosure to release the selectively deployable spear.

12. The pouch battery cell according to claim 4, wherein the selectively activated trigger mechanism is mounted external to the enclosure.

13. The pouch battery cell according to claim 12, wherein the selectively activated trigger mechanism includes a conduit fluidically connected to a vent passage.

14. The pouch battery cell according to claim 4, further comprising a battery monitoring system configured to selectively disconnect the pouch battery cell upon detecting gases passing from the enclosure.

15. A method of venting gases from a battery pack including a pouch battery cell having an anode including an anode terminal, a cathode including a cathode terminal, and an enclosure encapsulating the anode and the cathode, the enclosure being formed from a film having a surface, the method comprising:
detecting a stimulus in the enclosure;
activating a trigger mechanism to release a spear after detecting the stimulus; and
driving the spear though the surface of the film to vent the enclosure.

16. The method of claim 15, further comprising:
passing gases from the enclosure to a vent passage;
exhausting the gases from the vent passage; and
filtering the gases passing from the vent passage.

17. The method of claim 16, wherein passing the gases from the enclosure included directing the gases through the spear.

18. The method of claim 16, wherein passing the gases from the enclosure includes directing the gases from the triggering mechanism through a conduit selectively fluidically connecting the enclosure with the vent passage.

19. The method of claim 16, further comprising:
detecting gases in the vent passage with a battery monitoring system; and
electrically isolating the pouch battery cell.

20. The method of claim 15, wherein detecting the stimulus in the enclosure includes sensing one of a gas, a pressure, a temperature in the enclosure, and a sensed phase change.
